(19) United States
(12) Patent Application Publication
(10) Pub. No.: US 2026/0311946 A1
(43) Pub. Date: Oct. 8, 2026

(54) ELECTROMAGNETIC CONTACTOR HAVING STRUCTURE FOR IMPROVING OPERATION PERFORMANCE

(71) Applicant: LS E-MOBILITY SOLUTIONS CO., LTD., Cheongju-si, Chungcheongbuk-do (KR)

(72) Inventors: Jin Hee PARK, Cheongju-si, Chungcheongbuk-do (KR); Yeong Kyu LEE, Cheongju-si, Chungcheongbuk-do (KR); Je Hong SEO, Cheongju-si, Chungcheongbuk-do (KR)

(21) Appl. No.: 19/484,941

(22) PCT Filed: Jan. 29, 2024
(86) PCT No.: PCT/KR2024/001357

§ 371 Date: Nov. 17, 2025

(30) Foreign Application Priority Data
Jun. 23, 2023 (KR) 10-2023-0081135

(51) Int. Cl. H01H 50/18

(52) U.S. Cl. CPC H01H 50/18

(57) ABSTRACT

Disclosed is an electromagnetic contactor having a structure for improving operation performance, according to an aspect of the present disclosure, may comprise: a fixed contact point; a movable contact point which is positioned to be adjacent to the fixed contact point and is in contact with or spaced apart from the fixed contact point; a movable core coupled to the movable contact point so as to be movable in any one of a direction toward the movable contact point and a direction opposite to the movable contact point; a fixed core positioned between the movable contact point and the movable core and magnetized to apply a suction force to the movable core; and a magnetic body provided in an inner space provided in the movable core to add a magnetic force so as to lower an operation voltage of the movable core.

### CROSS-REFERENCE TO RELATED APPLICATIONS

This application is the National Stage filing under 35 U.S.C. 371 of International Application No. PCT/KR2024/001357, filed on Jan. 29, 2024, which claims the benefit of earlier filing date and right of priority to Korean Application No. 10-2023-0081135, filed on Jun. 23, 2023, the contents of which are all hereby incorporated by reference herein in their entirety.

### FIELD

The disclosure relates to an electromagnetic contactor, and more particularly, to an electromagnetic contactor having a structure for suppressing penetration of welding spatter and improving operation performance.

### BACKGROUND

In general, an electromagnetic contactor is a device which causes a contact between contacts by using a magnetic attractive force, which is generated by a current applied to an electromagnet. When the electromagnet produces a magnetic attractive force, a movable contact moves toward a fixed contact to be in contact with the fixed contact.

The fixed contact of the electromagnetic contactor is electrically connected to each of external power source and load. When the fixed contact and the movable contact are in contact, the external power source and load may be electrically connected to each other. When a current is not applied to the electromagnet any more, the magnetic attractive force produced by the electromagnet is also removed. Accordingly, the movable contact is separated from the fixed contact, so that the electrical connection between the external power source and load is released.

Typically, an electromagnetic contactor includes a movable core which moves toward a fixed core by a magnetic attractive force, and forms a core unit by including the fixed core and the movable core. The core unit supplies a driving force for a movable contact to move toward a fixed contact when an external control power is applied. The core unit supplies a driving force for the movable contact to be spaced apart from the fixed contact when the external control power is cut off.

Korean Registration Application No. 10-2452354 discloses a DC relay. Specifically, an electromagnetic contactor is disclosed in which the movable contact and the fixed contact are brought into contact with or open from each other to electrically connect or disconnect external power source and load.

However, to improve operation performance according to the operation of the DC relay disclosed in the prior art document, a structure is provided to widen an area of the movable core of the core unit and have an empty space therein.

However, the structure of the prior art document is difficult to control the operation performance, which results in reduced mass productivity, and additional processing is required when manufacturing the movable core, which results in minimal cost reduction.

In the DC relay disclosed in the prior art document, a movable shaft and the movable core are welded to each other to fix the same to each other. However, spatter, which is the term of droplets of molten metal or non-metallic material that are scattered or splashed during the welding process, may be generated and may enter the inner space of the movable core during assembling.

### SUMMARY

The disclosure is intended to solve the above problems, and an aspect of the disclosure is to provide an electromagnetic contactor having a structure for improving operation performance, which includes magnetic bodies in an inner space formed in a movable core of a core unit, to secure the operation performance of the electromagnetic contactor as much as possible while maintaining the maximum advantage corresponding to a structure of the movable core, and to immediately respond to a required operation performance by adjusting the number of magnetic bodies provided according to the required operation performance.

Another aspect of the disclosure is to provide an electromagnetic contactor having a structure for improving operation performance capable of suppressing spatter, which may be generated during welding, from entering an empty space inside a movable core of a core unit, by arranging a magnetic body in the empty space and welding the movable core to a movable shaft.

The problems to be solved in the disclosure may not be limited to the aforementioned, and other problems to be solved by the disclosure, which are not mentioned, will be obviously understood by a person skilled in the art based on the following description.

To achieve these and other advantages and in accordance with the purpose of the disclosure, as embodied and broadly described herein, there is provided an electromagnetic contactor having a structure for improving operation performance, the electromagnetic contactor including: a fixed contact; a movable contact located adjacent to the fixed contact and brought into contact with or spaced apart from the fixed contact; a movable core coupled to the movable contact to be movable in any one of a direction toward the movable contact and a direction opposite to the movable contact; a fixed core magnetized to apply an attractive force to the movable core; and a magnetic body installed adjacent to the movable core to apply a magnetic force.

At this time, the magnetic body may be a permanent magnet.

The magnetic body may be arranged as a plurality of magnetic bodies to adjust the magnetic force.

The electromagnetic contactor may further include a movable shaft having one end fixed to the movable contact to move together with the movable contact, and another end fixed to the movable core, the movable shaft may be installed through the movable core, and the magnetic body may include a through hole arranged to surround the movable shaft.

The magnetic body may be arranged as a plurality of magnetic bodies, each installed to form a layer along an outer surface of the movable shaft, such that a number of the magnetic bodies is adjusted.

In a state where the magnetic body is arranged. an end of the movable shaft may be welded so that the movable shaft and the movable core are fixed.

An operating voltage supplied to the fixed core may be adjusted according to a number of the magnetic bodies.

The movable core may include: an upper surface through which the through hole is formed; and a side surface extending from the upper surface in a downward direction opposite to the upper surface, such that an opening is formed at a lower portion thereof, and an inner space is formed to accommodate the magnetic body.

The electromagnetic contactor may further include a barrier wall extending up to the opening of the side surface along the through hole, so that the movable shaft is not in close contact with the magnetic body.

The barrier wall and the side surface may each have a cylindrical shape.

According to the configuration, the electromagnetic contactor having the structure for improving operation performance according to one aspect of the disclosure may include the magnetic body inside the movable core and thus lower an operating voltage by adding a magnetic force during operation with the fixed core, thereby providing maximum performance.

The electromagnetic contactor having the structure for improving operation performance according to one aspect of the disclosure can adjust the number of magnetic bodies arranged inside the movable core, thereby enabling the implementation of an operating voltage desired by a consumer.

The electromagnetic contactor having the structure for improving operation performance according to one aspect of the disclosure can suppress spatter, which is generated due to welding the movable core to the movable shaft in the state where the magnetic body is arranged inside the movable core and causes malfunction, from entering components.

The effects of the disclosure are not limited to those described above, and should be understood to include all effects that can be inferred from the configuration of the disclosure described in the detailed description or claims of the disclosure.

### BRIEF DESCRIPTION OF THE DRAWINGS

FIG. 1 is a perspective view of an electromagnetic contactor having a structure for improving operation performance according to an embodiment.

FIG. 2 is a cross-sectional view taken along line AA shown in FIG. 1.

FIG. 3 is a cross-sectional view taken along line BB shown in FIG. 1.

FIG. 4 is an exploded perspective view of an electromagnetic contactor having a structure for improving operation performance according to an embodiment.

FIGS. 5 and 6 are exploded perspective views, viewed from different directions, of main elements of some components of an electronic contactor having a structure for improving operation performance according to an embodiment.

FIG. 7 is an exploded perspective view of a coupling relationship between a movable core and peripheral components, which are some components of an electronic contactor having a structure for improving operation performance according to an embodiment.

FIG. 8 is a cross-sectional view of an operation of an electronic contactor having a structure for improving operation performance according to an embodiment.

### DETAILED DESCRIPTION

Hereinafter, an embodiment of the disclosure will be described in detail with reference to the accompanying drawings, to be easily practiced by those skilled in the art. The disclosure may be implemented in many different forms and is not limited to the embodiment described herein. To clearly explain the disclosure, parts not related to the description have been omitted in the drawings, and the same or equivalent components are given the same reference numerals throughout the specification.

The words and terms used in the disclosure and claims are not to be construed as limited in their usual or dictionary meanings, but should be interpreted with meaning and concepts consistent with the technical idea of the disclosure according to the principle that the inventor can define terms and concepts in order to explain his or her disclosure in the best way.

Therefore, the embodiment described in the disclosure and the configuration shown in the drawings correspond to a preferred embodiment of the disclosure, and do not represent all of the technical ideas of the disclosure, so the corresponding configuration may be replaced with various equivalents and modified examples at the time that the present disclosure is filed.

Terms such as “include” or “has” are used herein and should be understood that they are intended to indicate an existence of several components, functions or steps, disclosed in the specification, and it is also understood that greater or fewer components, functions, or steps may likewise be utilized.

Hereinafter, an electronic connector having a structure for improving operation performance according to an embodiment will be described with reference to the drawings.

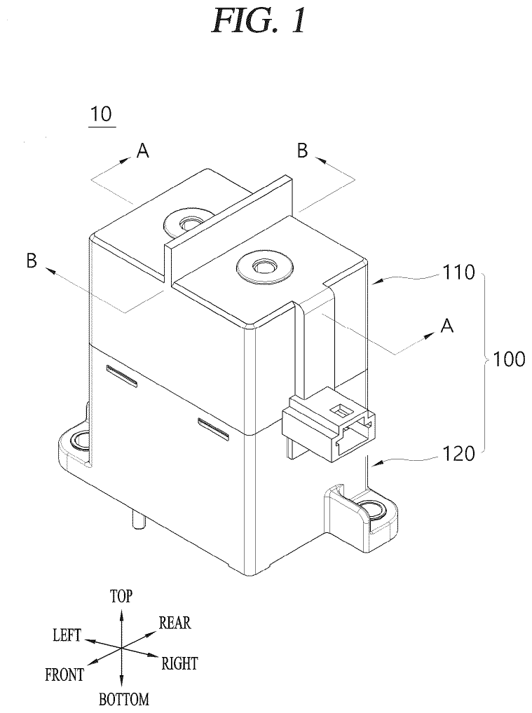

The terms “up,” “down,” “right,” “left,” “front,” and “rear” used in the following description will be understood based on a coordinate system shown in FIG. 1.

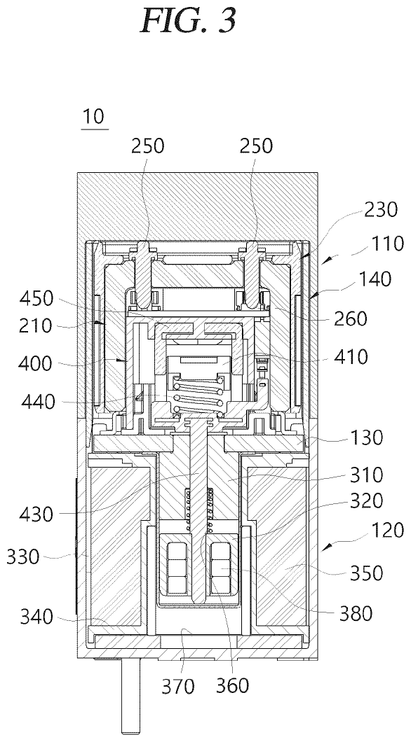

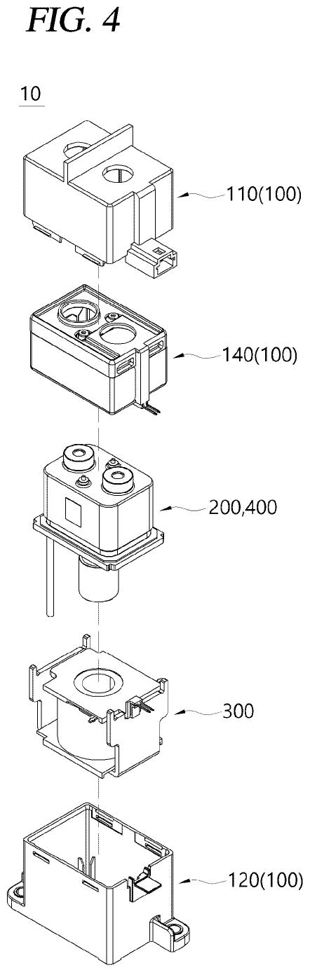

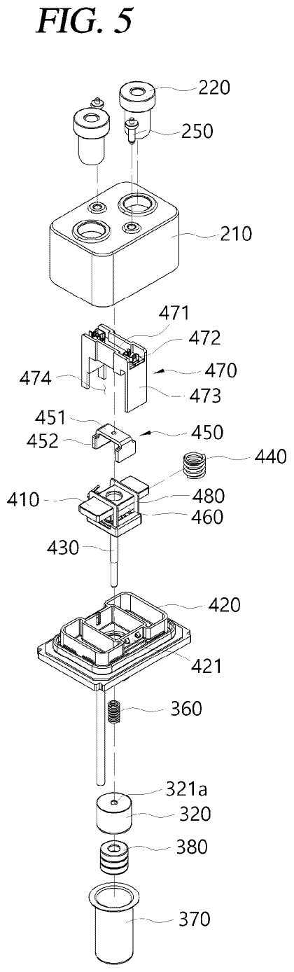

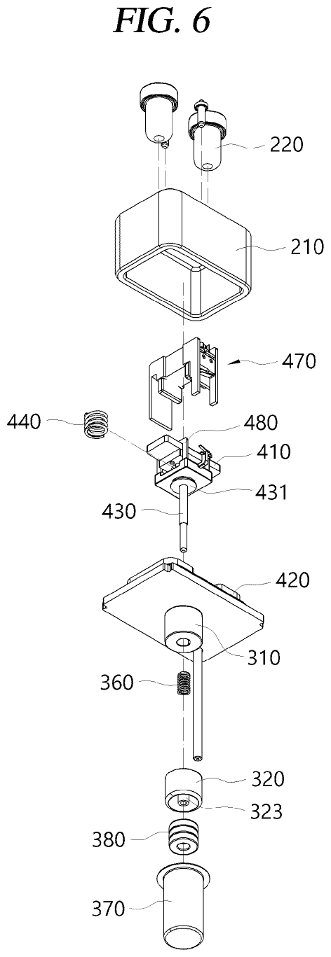

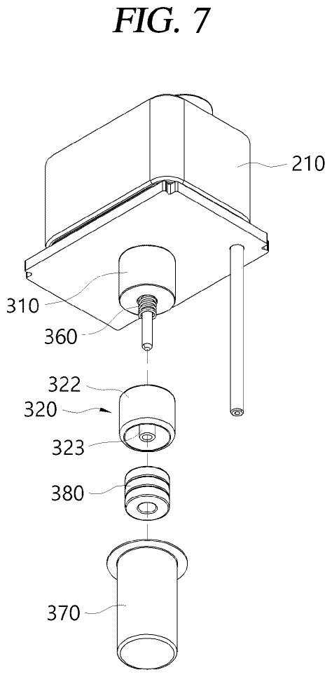

Referring to FIGS. 1 to 8, an electronic connector having a structure for improving operation performance according to an embodiment is shown. The electromagnetic contactor 10 is electrically connected to each of an external power source (not shown) and an external load (not shown). The electromagnetic contactor 10 may be configured to establish or release an electrical connection between the external power source (not shown) and the external load (not shown). To this end, the electromagnetic contactor 10 includes a fixed contact 220 and a movable contact 410 to be explained later.

The electromagnetic contactor 10 according to an embodiment includes an upper yoke 450 and a lower yoke 460 for offsetting an electromagnetic repulsive force, which is generated when the fixed contact 220 and the movable contact 410 are brought into contact with each other. At this time, the upper yoke 450 may be maintained at a certain height regardless of up and down movement of a component (for example, a movable shaft 430), which is arranged to be movable up and down.

Accordingly, even when the movable shaft 430 is moved up and down, the upper yoke 450 and the lower yoke 460 may be arranged to at least partially overlap each other, thereby generating a magnetic attractive force which is strong enough to attract each other. This can result in effectively offsetting an electromagnetic repulsive force which is generated when the fixed contact 220 and the movable contact 410 are brought into contact with each other.

In an embodiment, the electromagnetic contactor 10 may include an auxiliary contact housing 470. The auxiliary contact housing 470 is arranged in a movable contact assembly 400, but may be maintained at a certain height regardless of the up and down movement of the movable shaft 430. The auxiliary contact housing 470 may be electrically connected to an auxiliary contact 250, which is arranged to obtain information regarding the status of the electromagnetic contactor 10. Therefore, the information regarding the status of the electromagnetic contactor 10 can be stably obtained.

In some embodiments, the electromagnetic contactor 10 includes a movable contact support member 480. The movable contact support member 480 is formed to surround the movable contact 410 in at least one direction. The movable contact support member 480 is configured to suppress arbitrary rotation of the movable contact 410.

In the shown embodiment, the electromagnetic contactor 10 includes a housing 100, an opening and closing unit 200, a core unit 300, and a movable contact assembly 400.

The housing 100 define the appearance of the electromagnetic contactor 10. A space is formed inside the housing 100 to accommodate each component of the electromagnetic contactor 10. The space of the housing 100 is electrically connected to each of the external power source (not shown) and the external load (not shown).

In an embodiment, the space of the housing 100 may accommodate the opening and closing unit 200, the core unit 300, and the movable contact assembly 400. At this time, the fixed contact 220 of the opening and closing unit 200 may be partially exposed to outside to be electrically connected to each of the external power source (not shown) and the external load (not shown).

The space of the housing 100 communicates with the outside. An arc, which is generated when a fault current flows and thereby the fixed contact 220 and the movable contact 410 are spaced apart from each other may be discharged to the outside of the housing 100.

In the shown embodiment, the housing 100 includes an upper housing 110, a lower housing 120, a support plate 130, and an inner housing 140.

In an embodiment, the support plate 130 partially partitions the inner space of the upper housing 110 and the inner space of the lower housing 120. The support plate 130 supports some components of the movable contact assembly 400 on one side in a height direction, for example, on a lower side in the shown embodiment.

A through hole is formed through the inside of the support plate 130 in a thickness direction of the support plate 130, for example, in the vertical direction. A movable shaft 430 is accommodated in the through hole of the support plate 130 to be movable up and down.

The inner housing 140 supports the auxiliary contact 250 and an auxiliary contact cable 260 which is electrically coupled to the auxiliary contact 250. The inner housing 140 is connected to each of the auxiliary contact 250 and the auxiliary contact cable 260.

The inner housing 140 is accommodated in the inner space of the upper housing 110. The inner housing 140 is located inside the upper housing 110 and the opening and closing unit 200. Specifically, the inner housing 140 is located between a magnetic support member 230 and an arc chamber 210.

The arc chamber 210 may be accommodated in the inner housing 140 through the lower side. The inner housing 140 surrounds the accommodated arc chamber 210 from the outside.

The magnetic member 240 may generate a magnetic field in the arc chamber 210 accommodated in the arc chamber accommodation space 145. The generated magnetic field may form an extinguishing path for an arc which is generated when the fixed contact 220 and the movable contact 410 are spaced apart from each other.

The opening and closing unit 200 is configured to allow or block an electrical connection between the external power source (not shown) and the external load (not shown), which is electrically connected to the electromagnetic contactor 10, together with the movable contact assembly 400.

In the shown embodiment, the opening and closing unit 200 includes an arc chamber 210, a fixed contact 220, a magnetic support member 230, a magnetic member 240, an auxiliary contact 250, and an auxiliary contact cable 260.

The arc chamber 210 accommodates the fixed contact 220 and the movable contact 410.

The movable contact 410 may be movably accommodated in the arc chamber 210. When the fixed contact 220 and the movable contact 410 are spaced apart from each other due to a fault current, the arc chamber 210 may suppress a random leakage of the generated arc. For example, the arc chamber 210 is configured to suppress damage to other components of the electromagnetic contactor 10 due to the arc.

A magnetic field generated by the magnetic member 240 may be generated inside the arc chamber 210. The magnetic field may form a path through which the generated arc is extinguished and discharged to the outside.

The fixed contact 220 is coupled to the arc chamber 210.

The fixed contact 220 is a portion where the electromagnetic contactor 10 is electrically connected to the external power source (not shown) or the external load (not shown). The fixed contact 220 is connected to each of the upper housing 110, the inner housing 140, and the arc chamber 210. The fixed contact 220 extends in the height direction of the housing 100, for example, in the up-down direction in the shown embodiment.

One side of the fixed contact 220 in the height direction of the fixed contact 220, for example, an upper side in the shown embodiment, is exposed to the outside of the upper housing 110. The external power source (not shown) or the external load (not shown) may be electrically connected to the fixed contact 220 through the upper side.

It can be understood that the contact and separation between the fixed contact 220 and the movable contact 410 are achieved by the movement of the movable contact 410.

The magnetic support member 230 is coupled to the magnetic member 240 to support the magnetic member 240.

By means of the magnetic support member 230, the magnetic member 240 can be maintained at a preset position to generate a magnetic field inside the arc chamber 210.

The magnetic member 240 generates a magnetic field in the inner space of the arc chamber 210. The magnetic field generated by the magnetic member 240 may apply a magnetic force which induces an arc. The arc may be extinguished and discharged along a path induced by the magnetic field.

The magnetic member 240 may be arranged as two magnetic members, including a first magnetic member located on the left and a second magnetic member located on the right.

The auxiliary contact 250 is electrically connected to a substrate member (not shown) for collecting information regarding an operating status of the electromagnetic contactor 10. Information collected from the substrate member (not shown) may be transmitted to an external controller (not shown) via the auxiliary contact 250.

Accordingly, the operating status of the electromagnetic contactor 10 can be easily recognized even without disassembling the electromagnetic contactor 10.

The auxiliary contact 250 may be electrically connected to the auxiliary contact cable 260.

The auxiliary contact 250 is located between the pair of fixed contacts 220. In the shown embodiment, the auxiliary contact 250 is located between the pair of fixed contacts 220 along the longitudinal direction of the housing 100, for example, in the left-right direction.

The auxiliary contact cable 260 electrically connects the auxiliary contact 250 to the external controller (not shown). The auxiliary contact cable 260 is electrically connected to each of the auxiliary contact 250 and the external controller (not shown).

The core unit 300 supplies a driving force for the movable contact 410 to move toward the fixed contact 220 when external control power is applied. The core unit 300 supplies a driving force for the movable contact 410 in contact with the fixed contact 220 to move away from the fixed contact 220 when the external control power is cut off.

The core unit 300 is coupled to the housing 100. In some embodiments, some components of the core unit 300 are fixedly arranged in the space formed inside the lower housing 120. Other components of the core unit 300 are movably arranged in the space formed inside the lower housing 120. At this time, the other components of the core unit 300 may be arranged to be movable in the height direction of the lower housing 120, for example, in the up-down direction.

The core unit 300 is coupled to the movable contact assembly 400. A movable core 320 to be described later may be coupled to the movable shaft 430 of the movable contact assembly 400 to be movable together with the movable shaft 430.

In the shown embodiment, the core unit 300 includes a fixed core 310, a movable core 320, a magnetic body 380, a core yoke 330, a bobbin 340, coils 350, a return spring 360, and a cylinder 370.

The fixed core 310 is magnetized by applied control power and supplies a magnetic attractive force to the movable core 320. By the magnetic attractive force applied by the fixed core 310, the movable core 320 and the movable shaft 430 coupled to the movable core 30 may move toward the fixed core 310.

Accordingly, the movable contact 410 coupled to the movable shaft 430 can also move together, so that the movable contact 410 and the fixed contact 220 can be brought into contact with each other and electrically connected.

The fixed core 310 may be have any shape which can be magnetized by external control power and apply a magnetic attractive force to the movable core 320. In an embodiment, the fixed core 310 may be implemented as an electromagnet.

The fixed core 310 is coupled to the support plate 130. The fixed core 310 is accommodated in a space formed inside the cylinder 370. One side of the fixed core 310 in the height direction of the fixed core 310, for example, an upper side in the shown embodiment, is fixedly coupled to the support plate 130. Another side of the fixed core 310 in the height direction, for example, a lower side in the shown embodiment, is elastically supported by the return spring 360.

The movable core 320 is moved toward the fixed core 310 by a magnetic attractive force which is applied by the fixed core 310. The movable core 320 is moved away from the fixed core 310 by an elastic force which is applied by the return spring 360.

The movable core 320 is accommodated in the space formed inside the cylinder 370.

The movable core 320 is arranged to face the support plate 130 with the fixed core 310 located therebetween. In the shown embodiment, the movable core 320 is located below the fixed core 310.

The movable core 320 is coupled to the movable shaft 430. When the movable core 320 moves, the movable shaft 430 may also move. Accordingly, some components included in the movable contact assembly 400 may move together with the movable core 320.

The movable core 320 is elastically supported by the return spring 360. In some embodiments, one side of the movable core 30 in the height direction of the movable core 320, for example, an upper side in the shown embodiment, is supported by one end portion of the return spring 360 in the height direction of the return spring 360.

The movable core 320 may have any shape which can be moved toward the fixed core 310 by a magnetic attractive force which is applied by the fixed core 310. In an embodiment, the movable core 320 may be made of a metal material, such as magnetizable iron (Fe).

The movable core 320 may include a magnetic body 380 in the inner space thereof.

The magnetic body 380 may be installed in the inner space formed in the movable core 320 and configured to apply a magnetic force to lower an operating voltage of the movable core 320.

The magnetic body 380 may be arranged as a plurality of magnetic bodies to adjust the magnetic force. In the shown embodiment, the plurality of magnetic bodies 380 may be three magnetic bodies and may each have an annular token shape with a through hole 321a. Of course, the number of magnetic bodies 380 is not limited to three. The movable shaft 430 may be inserted through the through hole 321a.

In the shown embodiment, the magnetic body 380 does not need a separate fixing member because the movable core 320 itself is made of a material which is attached by a magnetic force, and may be sufficiently fixed to the inner space of the movable core 320 by the magnetic force.

The magnetic body 380 may be arranged as a plurality of magnetic bodies, and each magnetic body 380 may be installed to form a layer along an outer surface of the movable shaft 430. This may allow for the adjustment of the number of magnetic bodies 380. By adjusting the number of magnetic bodies 380 in this way, the operating voltage of the movable core 320 can be adjusted.

In the shown embodiment, for example, in case that an operating voltage for operating the existing movable core 320 is 7 to 8 V, the operating voltage may be lowered to 4 V or less by filling the inner space with the magnetic bodies 380 to the maximum. Of course, even at this time, the operating voltage may be adjusted to 4 to 7 V by adjusting the number of magnetic bodies 380.

In a state where the magnetic body 380 is arranged, an end portion of the movable shaft 430 may be welded to the movable core 320, so that the movable shaft 430 and the movable core 320 can be fixed. At this time, as the magnetic body 380 fills the inner space, welding spatter can be suppressed from entering the inner space during welding. Therefore, the malfunction of the movable core 320 due to the spatter can be suppressed in advance.

In the shown embodiment, the movable core 320 may include an upper surface 321 through which the through hole 321a is formed.

The movable core 320 may include a side surface 322 extending from the upper surface 321 in a downward direction opposite to the upper surface, such that an opening is formed at a lower portion thereof and an inner surface is formed to accommodate the magnetic body 380.

The movable core 320 may include a barrier wall 323 extending up to the opening of the side surface 322 along the through hole 321a to suppress the movable shaft 430 from being in close contact with the magnetic body 380. In the shown embodiment, the barrier wall 323 and the side surface 322 may each have a cylindrical shape.

An end portion of the barrier wall 323 of the movable core 320 and an end portion of the movable shaft 430 may be welded, so that the movable core 320 and the movable shaft 430 can be fixed to each other and move together. Of course, the penetration of welding spatter can be suppressed by virtue of the magnetic body 380 filled inside the movable core 320.

By arranging the magnetic body 380 in the movable core 320 in this way, the operating voltage for operating the movable core 320 can be lowered compared to an existing structure, thereby enhancing operating efficiency, and by adjusting the number of magnetic bodies 380, the operating voltage desired by a customer can be adjusted to a certain range.

The core yoke 330 functions as a fixed core with respect to a magnetic field which the coils 350 generates by applied control power. The core yoke 330 may be magnetized by the generated magnetic field to function as an electromagnet.

The core yoke 330 is coupled to the housing 100. In some embodiments, the core yoke 330 is accommodated in the inner space of the lower housing 120. The support plate 130 is located on one side of the core yoke 330 in the height direction of the core yoke 330, for example, on an upper side in the shown embodiment.

The core yoke 330 is arranged to surround the bobbin 340 and the coils 350. The core yoke 330 may be located adjacent to the coil 350 and may be magnetized by the magnetic field generated by the coils 350.

The bobbin 340 supports the coils 350. The coils 350 may be accommodated in the housing 100 while being wound on the bobbin 340. For example, the bobbin 340 functions as a type of bobbin.

The bobbin 340 is coupled to the housing 100. In some embodiments, the bobbin 340 is accommodated in the space formed inside the lower housing 120. As described above, the bobbin 340 is located radially inside the core yoke 330. A hollow hole may be formed inside the bobbin 340 so that the cylinder 370 is accommodated.

The coils 350 generate a magnetic field by receiving control power from the outside.

The core yoke 330 may be magnetized by the magnetic field generated by the coils 350, thereby generating a magnetic force for moving the movable core 320 toward the fixed core 310.

The coils 350 are coupled to the housing 100. In some embodiments, the coils 350 are accommodated in the space formed in the lower housing 120. The coils 350 are coupled to the bobbin 340. The coils 350 may be wound around an outer periphery of the bobbin 340.

The return spring 360 applies a restoring force for the movable core 320, which has moved toward the fixed core 310, to move away from the fixed core 310. The return spring 360 is located between the fixed core 310 and the movable core 320. The return spring 360 is accommodated in the inner space of the cylinder 370.

The return spring 360 may have any shape which can store a restoring force, in response to the movable core 320 moving toward the fixed core 310, and apply the stored restoring force to the movable core 320 when the control power is not applied any more. In the shown embodiment, the return spring 360 is configured as a coil spring.

In the embodiment, the return spring 360 extends in the height direction of the housing 100, for example, in the up-down direction. One end of the return spring 360 in the extension direction of the return spring 360 is in contact with the fixed core 310. Another end of the return spring 360 in the extension direction is in contact with the movable core 320. For example, the return spring 360 elastically supports the movable core 320.

The cylinder 370 movably accommodates the movable core 320 and the movable shaft 430 coupled to the movable core 320. In the shown embodiment, the cylinder 370 may extend in the height direction of the housing 100, for example, in the up-down direction, so that the movable core 320 and the movable shaft 430 are accommodated to be movable up and down.

The cylinder 370 is coupled to the bobbin 340. The cylinder 370 may be located in the hollow formed through the inside of the bobbin 340.

Referring to FIGS. 1 to 8, the electromagnetic contactor 10 according to an embodiment includes the movable contact assembly 400.

The movable contact assembly 400 according to an embodiment includes a plurality of yokes 450 and 460 configured to offset an electromagnetic repulsive force, which is generated when the fixed contact 220 and the movable contact 410 are brought into contact with each other. In particular, one yoke 450 of the plurality of yokes 450 and 460 may be maintained at a preset position regardless of the movement of the movable contact 410.

Accordingly, an area in which the plurality of yokes 450 and 460 are arranged to overlap each other can increase, compared to the case where the plurality of yokes 450 and 460 are all moved. Therefore, the magnetic attractive force between the plurality of yokes 450 and 460 can increase, so that the electromagnetic repulsive force generated between the fixed contact 220 and the movable contact 410 can be effectively offset.

The movable contact assembly 400 according to an embodiment includes the auxiliary contact housing 470 which is electrically connected to the auxiliary contact 250. The auxiliary contact housing 470 may include a substrate member (not shown) so as to transmit information regarding the operating status of the electromagnetic contactor 10 through the auxiliary contact 250.

Furthermore, in the movable contact assembly 400 according to an embodiment, the one yoke 450 may be coupled to the auxiliary contact housing 470. Accordingly, the overall volume of the movable contact assembly 400 can be reduced and assembly convenience can be improved.

Furthermore, regardless of the movement of the movable contact 410, the one yoke yoke 450 can be maintained at the preset position.

In the shown embodiment, the movable contact assembly 400 includes a movable contact 410, a movable frame 420, a movable shaft 430, a movable spring 440, an upper yoke 450, a lower yoke 460, an auxiliary contact housing 470, and a movable contact support member 480.

The movable contact 410 is brought into contact with or spaced apart from the fixed contact 220.

The movable contact 410 may be brought into contact with or spaced apart from the plurality of fixed contacts 220 simultaneously. When the movable contact 410 and the fixed contact 220 are brought into contact with each other, an external power source (not shown) and an external load (not shown) which are electrically connected to the electromagnetic contactor 10 may be electrically connected to each other.

The movable contact 410 is accommodated in the housing 100. In some embodiments, the movable contact 410 is movably accommodated in the arc chamber 210 which is accommodated in the inner space of the upper housing 110. In an embodiment, the movable contact 410 may be accommodated inside the arc chamber 210 so as to be movable in the height direction of the upper housing 110, for example, in the up-down direction.

The movable contact 410 is movably coupled to the movable frame 420. The movable contact 410 may move relative to the movable frame 420. For example, the movable frame 420 is not arbitrarily moved by being coupled to the support plate 130.

The movable core 410 is coupled to the movable shaft 430. When the movable core 320 coupled to the movable shaft 430 moves, the movable contact 410 may also move together.

The movable contact 410 is coupled to the movable spring 440. In some embodiments, the movable contact 410 is elastically supported by the movable spring 440. In the shown embodiment, a lower portion of the movable contact 410 is elastically supported by the movable spring 440.

The movable contact 410 is located adjacent to the upper yoke 450. The movable contact 410 may be arranged to be at least partially surrounded by the upper yoke 450. In the shown embodiment, one side of the movable contact 410 in the height direction of the movable contact 410, for example, an upper side, and each side in the width direction, for example, a front side and a rear side, are surrounded by the upper yoke 450.

The movable contact 410 is located adjacent to the lower yoke 460. The movable contact 410 may be in contact with the lower yoke 460 so as to be supported by the lower yoke 460. In the shown embodiment, a lower portion of the movable contact 410 is supported by the lower yoke 460.

The movable contact 410 may move together with the lower yoke 460.

The movable contact 410 is located adjacent to the auxiliary contact housing 470. The movable contact 410 may be arranged to be at least partially surrounded by the auxiliary contact housing 470. In the shown embodiment, one side of the movable contact 410 in the height direction of the movable contact 410, for example, the upper side, and each side in the width direction, for example, the front side and the rear side, are surrounded by the auxiliary contact housing 470.

The movable contact 410 may be supported by the movable contact support member 480. As will be described later, the movable contact support member 480 is formed to surround the movable contact 410 at at least one position along the longitudinal direction of the movable contact 410. In the shown embodiment, one side of the movable contact 410 in the height direction of the movable contact 410, for example, the upper side, and each side in the width direction, for example, the front side and the rear side, are surrounded by the movable contact support member 480.

The movable contact 410 may have any shape which is electrically connected by being brought into contact with the plurality of fixed contacts 220 simultaneously. In the shown embodiment, the movable contact 410 has a polygonal column shape having a length in the left-right direction, a width in the front-rear direction, and a height in the up-down direction.

At this time, the length of the movable contact 410 in the extension direction of the movable contact 410, for example, in the left-right direction, may be at least a distance by which the pair of fixed contacts 220 are spaced apart from each other. By the structure, the movable contact 410 can be simultaneously in contact with the plurality of fixed contacts 220.

The movable frame 420 is located adjacent to the movable contact 410.

The movable frame 420 is a component, which is mounted on the support plate 130, among the components of the movable contact assembly 400. The movable frame 420 may be fixed to the support plate 130 so as not to move arbitrarily.

A through hole is formed through the inside of the movable frame 420. The movable shaft 430 may be coupled through the through hole to be movable up and down.

The movable shaft 430 transmits the movement of the movable core 30 to the movable contact 410. The movable shaft 430 may be coupled to the movable core 320 and the movable contact 410 so as to move together.

The movable shaft 430 extends in the height direction of the housing 100, for example, in the up-down direction in the shown embodiment. One side of the movable shaft 430 in the height direction of the movable shaft 430, an upper side in the shown embodiment, is coupled to the movable contact 410 through a shaft holder 431. Another side of the movable shaft 430 in the height direction of the movable shaft 430, in the shown embodiment, a lower side, is coupled to the movable core 320.

The movable shaft 430 is coupled to the support plate 130. In some embodiments, the movable shaft 430 is movably inserted through an opening which is formed through the inside of the support plate 130.

The movable shaft 430 is coupled to the movable core 320. The movable shaft 430 is inserted through a hollow which is formed in the return spring 460, and is movably accommodated in the cylinder 370.

The movable shaft 430 is coupled to the movable contact 410. The movable shaft 430 may move together with the movable contact 410.

The movable shaft 430 is coupled to the movable frame 420. In some embodiments, the movable shaft 430 is inserted through an opening which is formed through the inside of the movable frame 420. The movable shaft 430 is movably coupled to the movable frame 420.

The movable shaft 430 supports the movable spring 440. In some embodiments, the movable shaft 430 is in contact with one side of the movable spring 440 in the longitudinal direction of the movable spring 440, for example, the lower side. Accordingly, the movable contact 410 and the lower yoke 460 can be elastically supported by the movable spring 440.

The movable shaft 430 is coupled to the movable contact support member 480. The movable shaft 430 may move together with the movable contact support member 480.

In the shown embodiment, the movable shaft 430 includes a shaft holder 431.

The shaft holder 431 is a portion where the movable shaft 430 is coupled with other components of the movable contact assembly 400. In the shown embodiment, the shaft holder 431 is coupled to the movable contact 410, the movable spring 440, the lower yoke 460, and the movable contact support member 480.

In some embodiments, the movable contact 410 and the lower yoke 460 are located to face the shaft holder 431 with the movable spring 440 arranged therebetween. The movable contact 410 and the lower yoke 460 are elastically supported by the movable spring 440.

The shaft holder 431 is located on one side of the movable shaft 430 in the longitudinal direction of the movable shaft 430, for example, on an upper side in the shown embodiment. The shaft holder 431 is located between the support plate 130 and the movable frame 420. At this time, the shaft holder 431 may be formed to have a cross-sectional area, which is greater than or equal to a cross-sectional area of the through hole formed inside each of the support plate 130 and the movable frame 420.

Accordingly, the shaft holder 431 can be maintained on the upper side of the support plate 130 and the movable frame 420 without passing through the through hole formed inside the support plate 130 or the movable frame 420.

A position at which the movable shaft 430 is movable in a direction opposite to the fixed contact 220, for example, downward in the shown embodiment, may be limited to a position at which the movable shaft 430 is in contact with the movable frame 420.

The movable spring 440 elastically supports the movable contact 410 and the lower yoke 460. The movable spring 440 is located between the movable contact 410 and the lower yoke 460 and the shaft holder 431. The movable spring 440 is located below the movable contact 410 and the lower yoke 460.

The movable spring 440 extends between the shaft holder 431 and the lower yoke 460. In the shown embodiment, the movable spring 440 extends in the extension direction of the movable shaft 430, for example, in the up-down direction. One end of the movable spring 440 in the extension direction of the movable spring 440, for example, an upper end, is in contact with the lower yoke 460. Another end of the movable spring 440 in the extension direction of the movable spring 440, for example, a lower end, is supported by the shaft holder 431.

When the movable shaft 430 moves toward the fixed contact 220, the movable spring 440 may be pressed by the shaft holder 431 to move together while storing a restoring force. The movable contact 410 can be pressed toward the fixed contact 220 by the stored restoring force, thereby stably maintaining the contact state between the fixed contact 20 and the movable contact 410.

The upper yoke 450 generates a magnetic attractive force together with the lower yoke 460. The magnetic attractive force generated by the upper yoke 450 and the lower yoke 460 can offset an electromagnetic repulsive force which is generated when the fixed contact 220 and the movable contact 410 are brought into contact with each other. Accordingly, the contact state between the fixed contact 220 and the movable contact 410 can be achieved and stably maintained.

The upper yoke 450 may have any shape which can generate the magnetic attractive force together with the lower yoke 460. In an embodiment, the upper yoke 450 may be made of a magnetic material having magnetism, for example, may be implemented as a permanent magnet.

The upper yoke 450 is located adjacent to the movable contact 410. At this time, the upper yoke 450 may be arranged to surround at least a portion of the movable contact 410 without being in contact with the movable contact 410.

The upper yoke 450 is located adjacent to the lower yoke 460. The upper yoke 450 may be arranged to surround the lower yoke 460 from the outside.

The electromagnetic contactor 10 according to an embodiment may be configured to minimize a separation distance between the upper yoke 450 and the lower yoke 460. This is achieved by the connection of the upper yoke 450 and the auxiliary contact housing 470.

For example, the upper yoke 450 is coupled to the auxiliary contact housing 470 so as not to move together with the movable contact 410 or the movable shaft 430. In other embodiments, the upper yoke 450 may be maintained at a preset position by the auxiliary contact housing 470, which is coupled to the fixedly arranged movable frame 420.

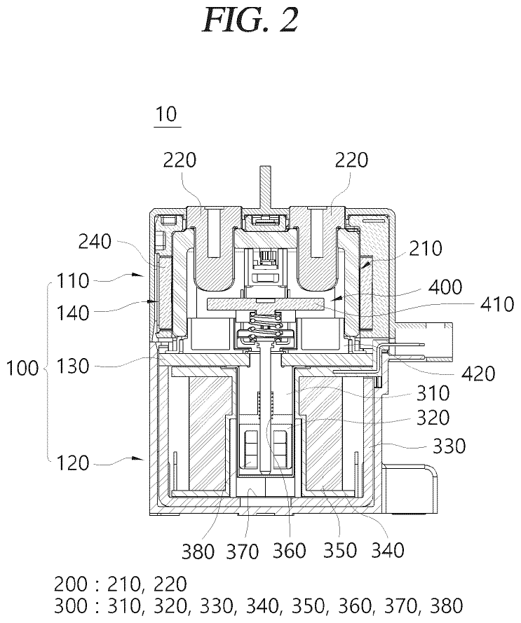

As shown in FIGS. 2 to 8, the upper yoke 450 is indirectly coupled to the movable frame 420 by the auxiliary contact housing 470. As described above, the movable frame 420 is supported by the support plate 130 and thus does not move independently of the movable shaft 430.

As the upper yoke 450 is coupled with the auxiliary contact housing 470, a volume of the shaft holder 431 can be reduced as much as a portion to which the upper yoke 450 is coupled. The strength of force required for the movement of the movable core 320 can also be reduced as much as the weight of the upper yoke 450 and the reduced volume of the shaft holder 431.

The upper yoke 450 may be divided into a plurality of portions. A portion of the upper yoke 450 may not be externally exposed by being accommodated in the auxiliary contact housing 470. Another portion of the upper yoke 450 may be exposed to the movable contact accommodation space 474 which is arranged in the auxiliary contact housing 470.

In the shown embodiment, the upper yoke 450 includes a first extension portion 451 and a second extension portion 452. The first extension portion 451 extends in the longitudinal direction of the auxiliary contact housing 470, for example, in the front-rear direction in the shown embodiment. The first extension portion 451 is not externally exposed by being accommodated inside the auxiliary contact housing 470. The first extension portion 451 surrounds the movable contact 410 and the lower yoke 460 on one side in the height direction, for example, on the upper side in the shown embodiment.

The first extension portion 451 may have a shape corresponding to the shape of the auxiliary contact housing 470. In the shown embodiment, the first extension portion 451 has a shape of a polygonal plate which has a length in the front-rear direction, a width in the left-right direction, and a thickness in the up-down direction.

Longitudinal ends of the first extension portion 451, for example, front and rear ends in the shown embodiment, are each continuous with the second extension portion 452.

The second extension portion 452 extends in the height direction of the auxiliary contact housing 470, for example, in the up-down direction in the shown embodiment. The second extension portion 452 is at least partially exposed to the outside of the auxiliary contact housing 470. In another example, a portion of the second extension portion 452 is located in the movable contact accommodation space 474. The second extension portion 452 is connected through a through hole (not given a reference numeral) formed inside the auxiliary contact housing 470.

The second extension portion 452 may be arranged as a plurality of second extension portions. The plurality of second extension portions 452 may each be arranged to be continuous with the first extension portion 451 and may be spaced apart from each other along the longitudinal direction of the first extension portion 451. In the shown embodiment, the second extension portion 452 is arranged as a pair of second extension portions continuous at a certain angle with the longitudinal ends of the first extension portion 451, for example, the front and rear ends. In an embodiment, the certain angle may be a right angle.

The second extension portion 452 surrounds the movable contact 410 and the lower yoke 460 in the width direction. In the shown embodiment, the second extension portion 452 surrounds the movable contact 410 and the lower yoke 460 on each of the front and rear sides.

The lower yoke 460 generates the magnetic attractive force together with the upper yoke 450. As described above, the magnetic attractive force can offset the electromagnetic repulsive force generated between the fixed contact 220 and the movable contact 410.

The lower yoke 460 may also have any shape which can generate the magnetic attractive force together with the upper yoke 450. In an embodiment, similar to the upper yoke 450, the lower yoke 460 may be made of a magnetic substance having magnetism, for example, may be implemented as a permanent magnet.

The lower yoke 460 is located adjacent to the movable contact 410. The lower yoke 460 is located on another side of the movable contact 410 in the height direction of the movable contact 410, for example, the lower side. The lower yoke 460 supports the movable contact 410 from the lower side.

The lower yoke 460 is elastically supported by the movable spring 440. In the shown embodiment, a lower surface of the lower yoke 460 is supported by being in contact with an upper end of the movable spring 440.

The lower yoke 460 is at least partially surrounded by the upper yoke 450 and the auxiliary contact housing 470 coupled with the upper yoke 450. In the shown embodiment, the upper, front, and rear sides of the lower yoke 460 are each surrounded by the upper yoke 450 and the auxiliary contact housing 470.

In some embodiments, the lower yoke 460 may move together with the movable shaft 430.

At this time, when the movable contact 410 moves to be in contact with the fixed contact 220, the lower yoke 460 may be arranged to at least partially overlap the upper yoke 450 along the horizontal direction. A detailed description thereof will be given later.

The auxiliary contact housing 470 includes a substrate member (not shown) to which the auxiliary contact 250 is electrically connected. The substrate member (not shown) may acquire information regarding the operating status of the electromagnetic contactor 10 and transmit the acquired information to the outside through the auxiliary contact 250.

The auxiliary contact housing 470 is coupled to the upper yoke 450 to support the upper yoke 450. As described above, by the coupling of the upper yoke 450 with the auxiliary contact housing 470, the position of the upper yoke 450 can be maintained constantly regardless of the movement of the movable shaft 430.

The auxiliary contact housing 470 is electrically connected to the auxiliary contact 250. At this time, the auxiliary contact housing 470 does not move, so the auxiliary contact housing 470 can be maintained in the electrically connected state by being coupled to the auxiliary contact 250.

The auxiliary contact housing 470 is coupled to the movable frame 420. At this time, the auxiliary contact housing 470 is at least partially accommodated in the auxiliary contact housing accommodating portion 421 and supported by the movable frame 420.

The auxiliary contact housing 470 is coupled with the upper yoke 450. A portion of the auxiliary contact housing 470 facing the movable contact 410, for example, a lower portion in the shown embodiment, is coupled with the upper yoke 450 The auxiliary contact housing 470 may at least partially accommodate the upper yoke 450. As described above, the first extension portion 451 of the upper yoke 450 is not externally exposed by being accommodated inside the auxiliary contact housing 470. The second extension portion 452 of the upper yoke 450 is externally exposed by being at least partially positioned in the movable contact accommodation space 474 arranged in the auxiliary contact housing 470.

To this end, a through hole (not given a reference numeral) may be formed through a lower surface among surfaces of the auxiliary contact housing 470. As described above, the second extension portion 452 may pass through the through hole (not given a reference numeral).

The auxiliary contact housing 470 may have any shape which is electrically connected to the auxiliary contact 250 and coupled to the upper yoke 450 to support the upper yoke 450. In the shown embodiment, the movable contact housing 470 has a shape of a solid figure having a length in the front-rear direction, a width in the left-right direction, and a height in the up-down direction.

At this time, the auxiliary contact housing 470 forms a space (for example, a movable contact accommodation space 474 to be explained later) therein to movably accommodate the movable contact 410 and the lower yoke 460.

In the shown embodiment, the auxiliary contact housing 470 includes an auxiliary contact plate 471, an auxiliary contact terminal 472, an auxiliary contact housing rack 473, and a movable contact accommodation space 474.

The auxiliary contact plate 471 configures a portion of the auxiliary contact housing 470. The auxiliary contact plate 471 supports the substrate member (not shown). The auxiliary contact terminal 472 is located on the auxiliary contact plate 471.

The auxiliary contact plate 471 is continuous with the auxiliary contact housing rack 473.

In the shown embodiment, the auxiliary contact plate 471 has each end in an extension direction thereof, for example, a front end and a rear end which are each continuous with the auxiliary contact housing rack 473.

The auxiliary contact plate 471 partially surrounds the movable contact accommodation space 474. In the shown embodiment, the auxiliary contact plate 471 surrounds the movable contact accommodation space 474 in the height direction, i.e., from the upper side.

The auxiliary contact plate 471 may have any shape which supports the substrate member (not shown) and the auxiliary contact terminal 472, is continuous with the auxiliary contact housing rack 473, and surrounds the movable contact accommodation space 474. In the shown embodiment, the auxiliary contact plate 471 has a plate shape which has a length in the front-rear direction and a width in the left-right direction.

At this time, a guide (not given a reference numeral) may extend in a height direction of the auxiliary contact plate 471 from each end of the auxiliary contact plate 471 in the width direction. The guide is configured to suppress arbitrary separation of the substrate member (not shown) or the auxiliary contact terminal 472.

The auxiliary contact terminal 472 is electrically connected to the auxiliary contact 250.

The auxiliary contact terminal 472 is electrically connected to the substrate member (not shown). Information collected by the substrate member (not shown) may be transmitted to the outside through the auxiliary contact terminal 472 and the auxiliary contact 250.

The auxiliary contact terminal 472 is coupled to the auxiliary contact plate 471. The auxiliary contact terminal 472 is located on an upper side of the auxiliary contact plate 471. In other embodiments, the auxiliary contact terminal 472 is arranged to face the auxiliary contact housing rack 473 with the auxiliary contact plate 471 located therebetween.

The auxiliary contact terminal 472 is coupled to the auxiliary contact 250. The auxiliary contact terminal 472 is maintained at a preset position regardless of the movement of the movable shaft 430, so that the auxiliary contact 250 and the auxiliary contact terminal 472 can be maintained in a contact state and an electrically connected state during the operation of the electromagnetic contactor 10.

The auxiliary contact terminal 472 may be arranged as a plurality of auxiliary contact terminals. The plurality of auxiliary contact terminals 472 may be arranged spaced apart from each other to be electrically connected to the plurality of auxiliary contact terminals 250, respectively. In the shown embodiment, two auxiliary contact terminals 472 are arranged to be spaced apart from each other in the longitudinal direction of the auxiliary contact plate 471, for example, in the front-rear direction.

In an embodiment, the auxiliary contact terminal 472 may be elastically coupled to the auxiliary contact 250. In the embodiment, the auxiliary contact terminal 472 may be electrically connected to the auxiliary contact 250 while pressing the auxiliary contact 250.

The auxiliary contact housing rack 473 constitutes another portion of the auxiliary contact housing 470. The auxiliary contact housing rack 473 is a portion where the auxiliary contact housing 470 is coupled to the movable frame 420. In some embodiments, the auxiliary contact housing rack 473 is at least partially accommodated in the auxiliary contact housing accommodating portion 421.

The auxiliary contact housing rack 473 is continuous with the auxiliary contact plate 471.

The auxiliary contact housing rack 473 extends in the height direction of the auxiliary contact housing 470, for example, in the up-down direction in the shown embodiment. At this time, the auxiliary contact housing rack 473 may be continuous with the longitudinal end of the auxiliary contact plate 471 at a certain angle.

The auxiliary contact housing rack 473 may be arranged as a plurality of auxiliary contact housing racks. The plurality of auxiliary contact housing racks 473 may be spaced apart from each other in the longitudinal direction of the auxiliary contact plate 471. The plurality of auxiliary contact housing racks 473 may partially surround the movable contact accommodation space 474 and the upper yoke 450 at different locations.

In the shown embodiment, the auxiliary contact housing racks 473 are arranged as a pair with being spaced apart from each other in the front-rear direction. The auxiliary contact housing rack 473 located on the front side surrounds the movable contact accommodation space 474 and the upper yoke 450 on the front side. The auxiliary contact housing rack 473 located on the rear side surrounds the movable contact accommodation space 474 and the upper yoke 450 on the rear side.

At this time, the auxiliary contact housing rack 473 may be in contact with the surface of the arc chamber 210. Specifically, outer surfaces of the auxiliary contact housing rack 473 in the width direction of the auxiliary contact housing rack 473, for example, a front surface of the front auxiliary contact housing rack 473 and a rear surface of the rear auxiliary contact housing rack 473, may be in contact with a front inner surface and a rear inner surface of the arc chamber 210, respectively.

Accordingly, the auxiliary contact housing 470 can be supported by the arc chamber 210. This can result in stably maintaining the coupled state between the auxiliary contact housing 470 and the movable contact assembly 400 including the auxiliary contact housing 470 and the opening and closing unit 200.

A space surrounded by the auxiliary contact plate 471 and the auxiliary contact housing rack 473 may be defined as the movable contact accommodation space 474.

The movable contact accommodation space 474 movably accommodates the movable contact 410 and the lower yoke 460. The movable contact 410 and the lower yoke 460 may move in a direction toward and a direction away from the fixed contact 220 while being accommodated in the movable contact accommodation space 474.

The upper yoke 450 is partially accommodated in the movable contact accommodation space 474. Some components of the upper yoke 450 may be coupled to the auxiliary contact plate 471, while the remaining components may be exposed to the movable contact accommodation space 474. The remaining components of the upper yoke 450 may be arranged to surround the movable contact 410 and the lower yoke 460.

The movable contact support member 480 suppresses the movable contact 410 from being randomly separated from the movable shaft 430. The movable contact support member 480 is coupled to each of the movable contact 410 and the shaft holder 431.

The movable contact support member 480 may be formed to at least partially surround the movable contact 410. In the shown embodiment, the movable contact support member 480 surrounds a portion of an upper side, a portion of a front side, and a portion of a rear side of the movable contact 410.

The movable contact support member 480 is coupled to the shaft holder 431. One side of the movable contact support member 480 in the height direction of the movable contact support member 480, for example, a lower side in the shown embodiment, may be fixedly coupled to the shaft holder 431.

The movable contact support member 480 may be arranged as a plurality of movable contact support members. The plurality of movable contact support members 480 may be spaced apart from each other along the longitudinal direction of the movable contact 410. The plurality of movable contact support members 480 may support the movable contact 410 at different positions.

In the shown embodiment, the movable contact support member 480 is arranged as a pair spaced apart from each other in the left-right direction. The pair of movable contact support members 480 are arranged to face each other with the auxiliary contact housing 470 located therebetween.

The movable contact support member 480 may be divided into a plurality of consecutive parts. In the shown embodiment, the movable contact support member 480 includes a first extension portion located on a front side thereof and extending in the up-down direction to surround the front side of the movable contact 410, a second extension portion located on an upper side and extending in the front-rear direction to surround the upper side of the movable contact 410, and a third extension portion located on a rear side and extending in the up-down direction to surround the rear side of the movable contact 410.

At this time, lower ends of the first extension portion and the third extension portion are coupled to the shaft holder 431. Upper ends of the first extension portion and the third extension portion are continuous with front and rear ends of the second extension portion, respectively, at a certain angle. In an embodiment, the certain angle may be a right angle.

The movable contact support member 480 may be configured to support the movable contact 410 in the width direction rather than a surface direction. In other embodiments, the movable contact support member 480 may support the movable contact 410 in a line-contact manner other than a surface-contact manner. Accordingly, the rigidity of the movable contact support member 480 can increase with respect to a fluctuation force applied by the movable contact 410, thereby effectively suppressing random fluctuation of the movable contact 410.

In an embodiment, the movable contact support member 480 may be arranged to be in contact with the movable contact 410. In the embodiment, arbitrary rotation or separation of the movable contact 410 can be more effectively suppressed.

In another embodiment, the movable contact 410 may have a groove formed to correspond to the movable contact support member 480. In the embodiment, the coupled state of the movable contact 410 and the movable contact support member 480 can be maintained more stably.

As described above, when the movable core 320 moves, the movable shaft 430 coupled to the movable core 320 can move together. At this time, the movable contact 410, the movable spring 440, the lower yoke 460, and the movable contact support member 480 move together with the movable shaft 430, but the auxiliary contact housing 470 and the upper yoke 450 coupled to the auxiliary contact housing 470 do not move.

Accordingly, the strength of force required for the movement of the movable contact 410 and other components can be reduced compared to the case where the auxiliary contact housing 470 and the upper yoke 450 move together with the movable shaft 430. Therefore, even though the strength of a magnetic force between the fixed core 310 and the movable core 320 is reduced, the movement of the movable contact 410 and the contact of the movable contact 410 with the fixed contact 220 can be easily performed.

Furthermore, the upper yoke 450 can be maintained at a preset position regardless of the movement of the movable shaft 430. Therefore, a distance between the upper yoke 450 and the lower yoke 460 can be reduced compared to the case where the upper yoke 450 moves together with the movable shaft 430.

This can result in applying a sufficiently strong magnetic attractive force between the upper yoke 450 and the lower yoke 460, so as to effectively offset an electromagnetic repulsive force generated between the fixed contact 220 and the movable contact 410.

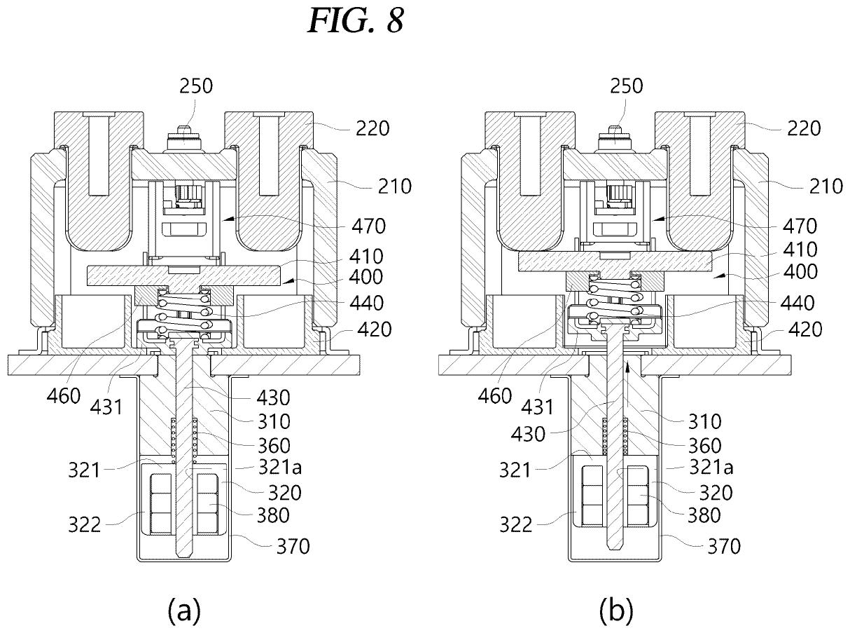

Referring to FIG. 8, an example of a process of operating the electromagnetic contactor 10 according to an embodiment is shown.

(a) of FIG. 8 shows a state in which the electromagnetic contactor 10 blocks an electrical connection between the external power source (not shown) and the external load (not shown). In the shown embodiment, the movable contact 410 is arranged spaced apart from the fixed contact 220 in the up-down direction.

At this time, a lower end of the upper yoke 450 is located lower than an upper end of the lower yoke 460. In the embodiment, it can be said that the upper yoke 450 and the lower yoke 460 are arranged to at least partially overlap each other along the horizontal direction.

(b) of FIG. 8 shows a state in which the electromagnetic contactor 10 allows the electrical connection between the external power source (not shown) and the external load (not shown). In the shown embodiment, the movable contact 410 is in contact with the fixed contact 220. Accordingly, an electromagnetic repulsive force can be generated between the movable contact 410 and the fixed contact 220.

Here, to achieve the electrically connected state, operating power may be supplied to generate a magnetic attractive force in the fixed core 310, such that the movable core 320 can move toward the fixed core 310. At this time, by virtue of the addition of the magnetic force of the magnetic body 380, lower operating power than the existing operating power can be supplied.

At this time, a lower end of the upper yoke 450 is located lower than an upper end of the lower yoke 460. In other words, the upper yoke 450 and the lower yoke 460 are arranged to at least partially overlap each other along the horizontal direction. At this time, it can be understood that an overlap area between the upper yoke 450 and the lower yoke 460 in the state shown in (b) of FIG. 8 is wider than an overlap area between the upper yoke 450 and the lower yoke 460 in the state shown in (a) of FIG. 8.

Accordingly, in the state where the movable contact 410 is in contact with the fixed contact 220 and electrically connected to the fixed contact 220, the strength of the magnetic attractive force generated between the upper yoke 450 and the lower yoke 460 can further increase. Therefore, the contact state between the movable contact 410 and the fixed contact 220 can be stably maintained.

Although the embodiment of the present disclosure has been described, the idea of the present disclosure is not limited to the embodiment presented in this specification, and those skilled in the art who understand the scope of the present disclosure can easily propose other embodiments by addition, change, deletion, etc. of components within the scope of the same technical idea, but it should be understood that those addition, change, deletion, etc. are embraced within the technical idea of the present disclosure.

The disclosure can be applied to the field of electromagnetic contactors.

1. An electromagnetic contactor having a structure for improving operation performance, the electromagnetic contactor comprising:
a fixed contact;
a movable contact located adjacent to the fixed contact and brought into contact with or spaced apart from the fixed contact;
a movable core coupled to the movable contact to be movable in any one of a direction toward the movable contact and a direction opposite to the movable contact;
a fixed core magnetized to apply an attractive force to the movable core; and
a magnetic body installed adjacent to the movable core to apply a magnetic force.

2. The electromagnetic contactor of claim 1, wherein
the magnetic body is a permanent magnet.

3. The electromagnetic contactor of claim 1, wherein
the magnetic body is arranged as a plurality of magnetic bodies to adjust the magnetic force.

4. The electromagnetic contactor of claim 1, further comprising
a movable shaft having one end fixed to the movable contact to move together with the movable contact, and another end fixed to the movable core,
wherein the movable shaft is installed through the movable core, and the magnetic body comprises a through hole arranged to surround the movable shaft.

5. The electromagnetic contactor of claim 4, wherein
the magnetic body is arranged as a plurality of magnetic bodies, each installed to form a layer along an outer surface of the movable shaft, such that a number of the magnetic bodies is adjusted.

6. The electromagnetic contactor of claim 5, wherein
in a state where the magnetic body is arranged, an end of the movable shaft is welded so that the movable shaft and the movable core are fixed.

7. The electromagnetic contactor of claim 4, wherein
an operating voltage supplied to the fixed core is adjusted according to a number of the magnetic bodies.

8. The electromagnetic contactor of claim 4, wherein
the movable core comprises:
an upper surface through which the through hole is formed; and
a side surface extending from the upper surface in a downward direction opposite to the upper surface, such that an opening is formed at a lower portion thereof, and an inner space is formed to accommodate the magnetic body.

9. The electromagnetic contactor of claim 8, further comprising
a barrier wall extending up to the opening of the side surface along the through hole, so that the movable shaft is not in close contact with the magnetic body.

10. The electromagnetic contactor of claim 9, wherein
the barrier wall and the side surface each have a cylindrical shape.
